(19) United States
(12) Patent Application Publication
(10) Pub. No.: US 2007/0271551 A1
(43) Pub. Date: Nov. 22, 2007

(54) Electronic Control Unit and Method for Specifying a Software Architecture for an Electronic Control Unit

(76) Inventors: Thomas Zurawka, Stuttgart (DE); Joerg Schaeuffele, Erlingheim (DE)

Correspondence Address: KENYON & KENYON LLP, ONE BROADWAY, NEW YORK, NY, 10004, US

(21) Appl. No.: 10/561,737

(22) PCT Filed: Jun. 24, 2004
(86) PCT No.: PCT/DE04/01333

§ 371 Date: Mar. 19, 2007

(30) Foreign Application Priority Data
Jun. 24, 2003 (DE) 103 28 240.8

(51) Int. Cl. G06F 9/44

(52) U.S. Cl. 717/120

(57) ABSTRACT

An electronic control unit having implemented on it, and made up of components, a software and a plurality of software interfaces, optimized with respect to the exchange of data, for the optional coupling in of a plurality of applications, the software including at least one application-specific software code of a component for each application capable of being coupled in, which is activated when the application is coupled in. The present arrangement also relates to a corresponding method for the specification of a software architecture of an electronic control unit.

### FIELD OF THE INVENTION

The present invention relates to an electronic control unit and a method for specifying a software architecture for an electronic control unit. The present invention also relates to a computer program having program code means for carrying out a method for specifying a software architecture

### BACKGROUND INFORMATION

The increasing complexity of the functions of an electronic control unit, and the increasing networking and interaction of control units among one another, such as, for instance, in a vehicle composite, and with external applications, enormously increase the software requirements of such control units. This applies not only to control units in the vehicle composite, but also to networking and interaction of control units and modules in other technical fields, such as automation.

Starting from the software requirements, software development begins with its analysis and the specification of a corresponding software architecture. In this context, one first determines or specifies the limitations of the software to be implemented on a corresponding electronic control unit.

In connection with the use of control units in the vehicle composite, it is known that, during development, one may use other control units than the ones in production or in service, such as mass-produced control units, which are then actually designated as development, prototype, sample or application control units. As a rule, these control units differ from mass-produced control units, among other things, by a so-called off-board interface modified for the respective development application, which is usually linked with hardware and software adaptations. Communication between a tool and a microcontroller of the control unit then takes place via various types of interface. Thus, for example, methods are standardized in ASAM for the functions of measuring, calibrating, diagnosis and flash programming.

### SUMMARY OF THE INVENTION

An electronic control unit is made available, having a software implemented on it, made up of components, and it has a plurality of software interfaces, optimized with respect to the exchange of data F, for the optional coupling in of a plurality of applications, the software including at least one application-specific software code, of a component for each application that can be coupled in, which is activated when the application is coupled in.

In general, one differentiates between two types of data that influence the sequence or the activation of a software code of a software component, and are transmitted via software interfaces. In this context, on the one hand, data information is involved and on the other hand, control or regulating information. As to the software interfaces, the corresponding distinction is made between data interfaces and control or regulating interfaces. The processing of information in a software system is designated as data flow or control flow. If, for example, a so-called CAN (control area network) message, that is, a message that is received via a CAN bus, reaches a microprocessor, this first gives the microprocessor a signal that a message has arrived, which is also denoted as an interrupt. In this context, a control information is then involved. The content of the CAN message, such as, for instance, the value of a transmitted signal, may, by contrast, be data information. This distinction applies both to input interfaces and output interfaces of a software system and also to the interfaces of the internal components of a software system.

In one additional preferred specific embodiment of the electronic control unit according to the present invention, the software interfaces are grouped into “on board” and “off board” interfaces as a function of the applications that may be respectively coupled in to them. The electronic control unit is generally integrated into a higher level linkage, such as a vehicle composite. In the light of this linkage, the boundaries of the software of the electronic control unit are now determined or fixed. It is accurately specified what belongs to the software of the electronic control unit and what belongs to the environment or the context of the software. Via this it is then determined what input and output interfaces the electronic control unit has. Furthermore, those software interface applications internal to the linkage that are designated as “on board” interfaces within the scope of the present invention, and, by contrast, those software interface applications external to the linkage that are designated as “off board” interfaces within the scope of the present invention, are then exactly determined. The “on board” interfaces are, for example, interfaces to setpoint value generators, sensors and actuators, as well as interfaces for a communication internal to the linkage, a so-called on board communication with other electronic systems of the linkage, such as a vehicle. The control unit according to the present invention has, as off board interfaces, all software interfaces that are required for an off board communication. If, for example, the electronic control unit is integrated into a vehicle composite, then it has all the software interfaces which are required during the course of development, during production or during the service of the vehicle for communication with electronic units external to the vehicle. In this context, with regard to the external units, for instance, tools may be involved which execute certain functions, such as measuring, calibrating, diagnosing or programming. Each tool needs a description of the “off board” interface to which it may be coupled. This description is filed, for instance, in the form of a data file, a so-called descriptive data file. This describes, on the one hand, hardware and software information of the “off board” interface, and on the other hand, information for access of the tool to the data of the electronic control unit, such as, for instance, the memory addresses of signals, variables and parameters are filed.

In one especially preferred specific embodiment of the electronic control unit, in this context, the software of the electronic control unit has a hierarchical layer architecture with respect to a mutual access possibility of the software components, each software component being assigned to one layer. The layers have the distinction that software components within one layer may access one another as needed, but strict rules apply between different layers. Correspondingly, the layers are situated according to abstraction levels assigned to them. Layers having higher abstraction levels may access layers having lower abstraction levels. On the other hand, access of lower layers to higher layers is strictly limited or is inadmissible.

Consequently, the software components are organized strictly into task-related, i.e. functional layers. In this context, the layer architecture preferably implements a separation of hardware-independent software components from hardware-dependent software components. This means that thereby a separation of the actual control unit functionality, that is, the hardware-independent software components, such as application software, from the hardware-dependent software components of the platform software is carried out. The setting, maintenance and reuse of the individual software components is made considerably easier thereby. The platform software or the corresponding software components may be used across different configurations. The software interfaces optimized, according to the present invention, with respect to the exchange of data are standardized, in this context, for access to the control unit. This makes possible the use of standardized methods, or tools adjusted to these standard interfaces, during the development, during production and in service, for example, for rapid prototyping, debugging, measuring and calibrating. In addition, the software components of the application software may be specified hardware-independent, and are thus portable to different control unit platforms.

In a further preferred specific embodiment of the electronic control unit, the software assumes in each case one of several possible operating states, as a function of data present at the software interfaces, and then supports exclusively condition-specific functionalities. A parameterization of software components and a software update take place in production, and in the service update there take place in production and in service, for example, mostly in a specific operating state of the software in which control functions, regulating functions and monitoring functions are allowed, for security reasons, to be carried out only partially or not at all.

In one preferred specific embodiment of the electronic control unit according to the present invention, the software may assume as operating state a “software update” state, a “software parameterization” state, a “software diagnosis” state, a “coasting” state, a “monitoring” state, an “on” state or an “operation under emergency conditions” state. Which state is assumed by the control unit depends on the information present at its software interfaces. If, for example, the electronic control unit is integrated into a vehicle, the operating state “on” may be assumed, for example, upon switching on the ignition of the vehicle. In this operating state then, for example, all indicating functionalities of the electronic control unit are available. If the software assumes operating state “software update” only flash programming via an “off board” diagnosis interface is supported in production and in service. Operating state “software parameterization” is provided for a setting of software parameters via the above-mentioned “off board” diagnosis interface, in production or in service. In the case of a vehicle composite, in this context, for example, switching over of route indications and speed indications between kilometers and miles, or a switching over between various language variants may be involved. In operating state “software diagnosis” of the software, the software only supports diagnosis functionalities, such as functions for sensor and actuator diagnosis, as well as the reading out and deleting of the error memory. These functionalities are advantageously only available in this operating state or are only supported on the part of the software in this operating state of the software. Furthermore, the software may assume operating state “monitoring”, such as, for example, after the turning of the ignition key to a specific position in a vehicle, whereby monitoring functionalities on the part of the software are then supported. Lastly, the software may assume an operating state “coasting”, such as after shutting down the engine of a vehicle, into which the electronic control unit is integrated. In this context, for example, memory functionalities and more time-consuming monitoring functionalities are supported. In addition, an operating state “operation under emergency conditions” is conceivable, which, on the part of the software is assumed, for example, in response to a failure of safety-relevant components, and in which the software supports functionalities which make possible continued operation with restricted functionality.

Preferably, besides the operating states, admissible transitions between the individual operating states are also established, as well as transition conditions. In this context, advantageously, finite state machines are used for specification.

Furthermore, the present invention includes the use of an electronic control unit according to the present invention in an automobile electronic system, preferably for controlling operating sequences in a vehicle.

In addition, the present invention makes available a method for specifying a software architecture for an electronic control unit. In this context, in a first step, defined software interfaces are specified. This means that at this point the “on board” interfaces and the “off board” interfaces described above are established. In a second step, software components and their interfaces are specified. In this context, communication between the software components is also determined. In an additional step, software layers and possible operating states are determined. In a subsequent step, automatically an assignment of the software components to the software layers and to the software operating states is undertaken, the assignments being verified by subsequent analysis and checking of the interactions implemented based on the assignments.

In one preferred specific embodiment of the method according to the present invention, in the case of insufficient assignments, the software components are subdivided into specified subcomponents and/or the software layers into specified sublayers and/or the software operating states into specified substates, whereupon a renewed assignment is carried out automatically.

With the aid of the method according to the present invention, for the specification of a software architecture for an electronic control unit, it is taken into consideration that there are numerous interactions between the specification of software components, software layers and operating states. By taking these factors into consideration during the development of the software architecture, the software is able to be used universally for all applications, and, when the electronic control unit is used, it does not require adjustments that have to be carried out only at that point.

Moreover, the present invention makes available a computer program and a computer program product having program code means, the method according to the present invention being automatically carried out when the program code means are executed on a computer or on a computer system.

### BRIEF DESCRIPTION OF THE DRAWINGS

FIG. 1 shows a schematic representation of a specific embodiment of an electronic control unit according to the present invention.

FIG. 2 shows a schematic representation of a software architecture of an additional specific embodiment of an electronic control unit according to the present invention.

### DETAILED DESCRIPTION

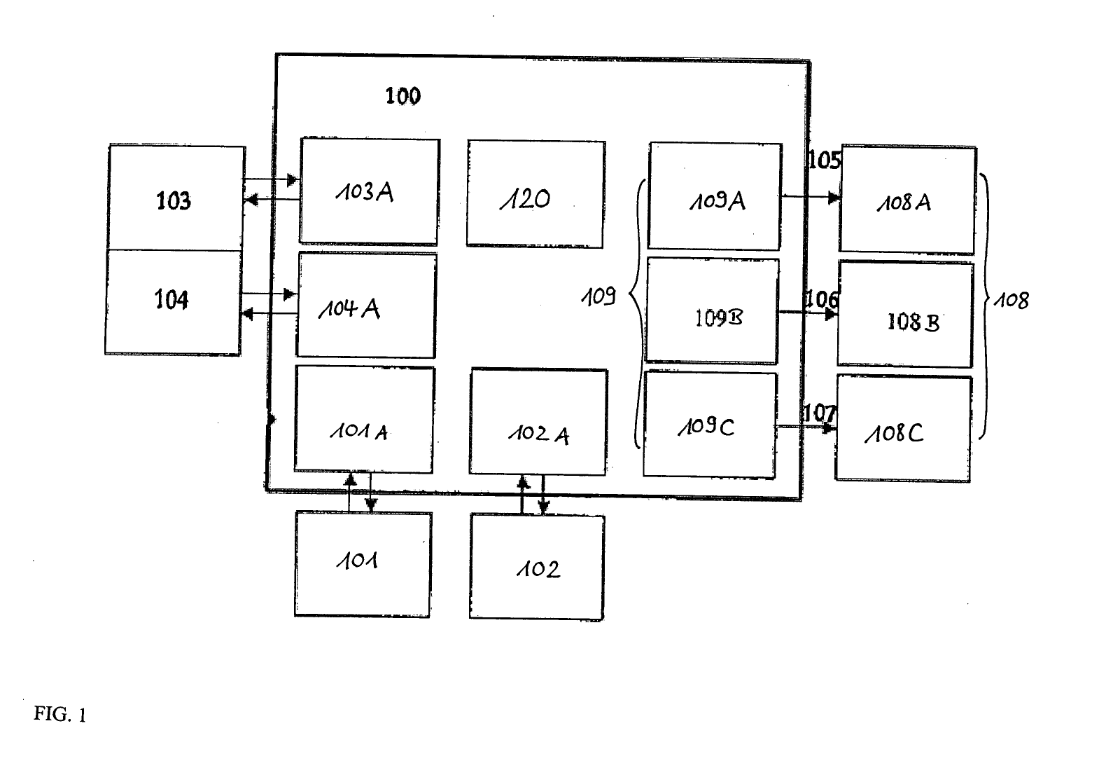

FIG. 1 shows an electronic control unit 100. The electronic control unit 100 is integrated into a higher level composite system, such as a vehicle, especially one having several control units, sensors and actuators. Besides the interfaces of internal components of control unit 100, that is, interfaces within control unit 100, there are also interfaces to applications within the higher level composite, which represent the “on board” interfaces. Control unit 100 shows as “on board” interfaces a CAN interface 101 and a MOST (media oriented system transport) interface 102, via which data may be exchanged both ways. Sensors and actuators of the higher level composite, such as of the vehicle, for example, may be coupled in at the CAN interface. The appertaining drivers to the CAN interface or to the MOST interface are marked 101A and 102A. Also shown are an analog (103) and a digital (104) input and output (analog I/O, digital I/O), along with the respective appertaining drivers 103A and 104A. Additionally interfaces 106, 106, 107 are shown, to which, for example, various display applications 108 may be coupled in which receive data from corresponding drivers 109 of the control unit. In this context, when it comes to display applications, for example, a directional indicator control 108A, a display control 108B or an LED control 108C may be involved. In this example then, driver 109A is developed as a directional indicator driver, 109B as a display driver and 109C as an LED driver. Element 20 shows additional functions of the control unit, such as calculating functions or processing functions along with the corresponding objects on which these are to be executed.

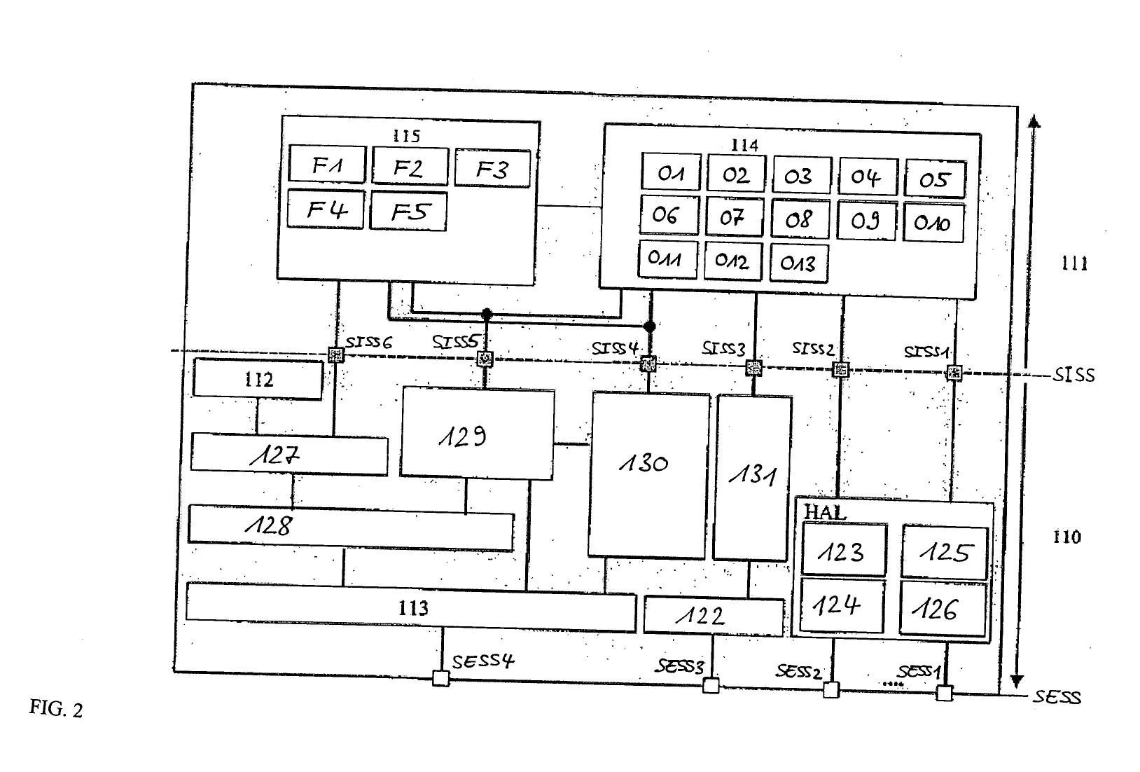

FIG. 2 shows a software architecture of an electronic control unit 100. In this context, the software components are assigned to layers, here, for example, to a platform layer 110 and to an application layer 111. Here, in platform layer 110, a CAN driver 113 and a MOST driver 122 having appertaining MOST network services 131 are included. In this context, there also comes about a separation of hardware-dependent software components, of the so-called platform software 110 and hardware-independent software components, of so-called applications software 111. In this context, platform software 110 includes the operating system, for example OSEK-OS, and so called hardware abstraction layer (HAL) for the definition of general standardized interfaces for interfacing to these hardware-dependent software components for various selectable hardware-independent software components. In this context, HAL includes, for example, the already mentioned directional pointer drivers 123, display drivers 124, LED drivers 125 and I/O driver 126. The hardware-independent software components in layer 111 may, for example, include software functions 115 for controlling operational sequences in a vehicle. In this context, display functions and/or computation functions and/or processing functions or control and/or regulating functions F1 to F5, summarized under 115, may be involved, as well as, on the other hand, corresponding objects 01 to 03, summarized under 114, on which these functions are to be executed. The software-internal interfaces SISS between platform software 110 and application software 111 are shown schematically in this context, and are not to be seen restrictive with regard to their exact position and connection. That means, for instance, that connections SISS1 and SISS2 between HAL and objects 114 are shown in exemplary fashion and schematically. This also applies to the remaining software-internal interfaces SISS3 to SISS6, any other connection and position being similarly possible. However, the principle becomes clear that, within layers 110 and 111, various components are networked with one another, while, for example, with regard to platform software 110, only the uppermost components, except for flash loader 112, have an interface SISS to the application software. Thus, for example, there is no interface that makes possible a direct passing on of the information present at CAN driver 113 to application software 111.

In general, one differentiates between two types of data that influence the sequence or the activation of a software code of a software component, and are transmitted via software interfaces, such as the above-named software-internal interfaces SISS. In this context, on the one hand, data information is involved and on the other hand, control or regulating information. As to the software interfaces, the corresponding distinction is made between data interfaces and control or regulating interfaces. This distinction applies both to input and output interfaces of a software system, which are designated here as SESS, that is software-external interfaces, and to interfaces SISS of the internal components of the exemplary software system in FIG. 2.

In this context, the software interfaces may be grouped into “on board” and “off board” interfaces as a function of the respective applications that may be coupled to them, and may thus be further refined. The electronic control unit is generally integrated into a higher level linkage, such as a vehicle composite. In the light of this linkage, the boundaries of the software of the electronic control unit are now determined or fixed. It is accurately specified what belongs to the software of the electronic control unit and what belongs to the environment or the context of the software. Via this it is then determined what input and output interfaces the electronic control unit has. Furthermore, those software interface applications internal to the linkage that are designated as “on board” interfaces within the scope of the present invention, and, by contrast, those software interface applications external to the linkage that are designated as “off board” interfaces within the scope of the present invention, are then exactly determined. The “on board” interfaces are, for example, interfaces to setpoint value generators, sensors and actuators, as well as interfaces for a communication internal to the linkage, a so-called on board communication with other electronic systems of the linkage, such as of a vehicle. In this context, interfaces SESS may be on board interfaces such as SESS1 and SESS2 to vehicle-internal hardware via HAL, or they may be off board interfaces such as via CAN driver 113 to interface SESS4 to an external diagnosis unit. However, interface SESS4 may also be vehicle-internal, that is, an on board interface, for instance, to actuators, sensors or additional control units via CAN bus. The same applies to MOST interface 122 and SESS3.

In this example, for instance, 127 designates an ISO diagnosis protocol, and 128 designates an ISO network layer. In platform software 110, 129 represents an interaction layer OSEK-COM and 130 represents a network management OSEK-NM.

The hierarchical layer architecture mentioned is thus shown in this case in exemplary fashion by two layers 110 and 111, each software component being assigned to one layer. The layers have the distinction that software components within one layer may access one another as needed, but strict rules apply, via interfaces SISS, between different layers. Correspondingly, the layers are situated according to abstraction levels assigned to them. Layers having higher abstraction levels may access layers having lower abstraction levels. On the other hand, access of lower layers to higher layers is strictly limited or is inadmissible. In this context, additional layers might be, for example, a sensor system layer or even an actuator layer, which are not explicitly shown here however, for reasons of clarity.

Consequently, the software components are organized strictly into task-related, i.e. functional layers. However, in this context, the layer architecture preferably implements a separation of hardware-independent software components from hardware-dependent software components. This means that, thereby, a separation of the actual control unit functionality, that is, of the hardware-independent software component, such as application software, is executed by the hardware-dependent software components of the platform software, having the advantages already described, the software interfaces optimized with respect to the exchange of information, according to the present invention, being, in this context, being standardized for access to the control unit.

In this context, the software assumes in each case one of several possible operating states, as a function of data present at the software interfaces and then supports exclusively condition-specific functionalities. As operating state, for instance, a “software update” state, a “software parameterization” state, a “software diagnosis” state, a “coasting” state, a “monitoring” state, an “on” state or an “operation under emergency conditions” state is conceivable. Which state is assumed by the control unit depends, as was said before, on the information present at its software interfaces.

Preferably, besides the operating states, admissible transitions between the individual operating states are also established, as well as transition conditions. In this context, advantageously, finite state machines are used for specification.

In addition, in the layers there may exist sublayers or subcomponents, so that, in the case of insufficient assignments, the software components are subdivided into specified subcomponents and/or the software layers into specified sublayers and/or the software operating states into specified substates, whereupon a renewed assignment is carried out automatically.

With the aid of the method according to the present invention, for the specification of a software architecture for an electronic control unit, it is consequently taken into consideration that there are numerous interactions between the specification of software components, software layers and operating states. By taking these factors into consideration during the development of the software architecture, the software is able to be used universally for all applications, and, when the electronic control unit is used, it does not require adjustments that have, just then, to be carried out.

1-11. (canceled)

12. An electronic control unit, comprising:
a software module including software that includes components, wherein:
the software includes a plurality of software interfaces that are optimized with respect to an exchange of data and provided for an optional coupling in of a plurality of applications, and
the software includes at least one application-specific software code of a component for each application capable of being coupled in, the at least one application-specific code being activated when the application is coupled in.

13. The electronic control unit as recited in claim 12, wherein:
the software has a hierarchical layer architecture with respect to a mutual access possibility of the software components, each software component being assigned to a layer.

14. The electronic control unit as recited in claim 13, wherein:
the hierarchical layer architecture implements a separation of hardware-independent software components from hardware-dependent software components.

15. The electronic control unit as recited in claim 12, wherein:
the software interfaces are grouped into “on board” and “off board” interfaces as a function of the respective applications that may be coupled to them.

16. The electronic control unit as recited in claim 12, wherein:
the software assumes in each case one of several possible operating states, as a function of data present at the software interfaces and therein supports exclusively condition-specific functionalities.

17. The electronic control unit as recited in claim 12, wherein:
the software may assume, as the operating state, one of a “software update” state, a “software parameterization” state, a “software diagnosis” state, a “coasting” state, a “monitoring” state”, and an “on” state.

18. The electronic control unit as recited in claim 12, wherein the electronic control unit is used in an automobile electronic system for controlling operating sequences in a vehicle.

19. A method for specifying a software architecture for an electronic control unit, comprising:
after a specification of defined software interfaces, of software components, of software layers, and of software operating states, automatically assigning in each case the software components to the software layers and to the software operating states; and
verifying assignments made by the automatically assigning step by performing a subsequent analysis and checking interactions implemented based on the assignments.

20. The method as recited in claim 19, further comprising:
in the case of insufficient assignments, subdividing at least one of the software components into specified subcomponents, the software layers into specified sublayers, and the software operating states into specified substates; and
automatically carrying out a renewed assignment.

21. A computer program having a program code that when executed results in a performance of the following:
after a specification of defined software interfaces, of software components, of software layers, and of software operating states, automatically assigning in each case the software components to the software layers and to the software operating states; and
verifying assignments made by the automatically assigning step by performing a subsequent analysis and checking interactions implemented based on the assignments 22. The computer program as recited in claim 21, wherein:
the computer program is embodied in a computer program product.
